(19) United States
(12) Patent Application Publication
(10) Pub. No.: US 2026/0108960 A1
(43) Pub. Date: Apr. 23, 2026

(54) METHODS AND SYSTEMS FOR IN-POCKET TENDON SHEARING

(71) Applicant: POST TECH MANUFACTURING, LLC, Fort Worth, TX (US)

(72) Inventors: Evan Langston, Fort Worth, TX (US); Bryant Morgan, Maryland Heights, MO (US)

(73) Assignee: POST TECH MANUFACTURING, LLC, Fort Worth, TX (US)

(21) Appl. No.: 19/361,703

(22) Filed: Oct. 17, 2025

Related U.S. Application Data
(60) Provisional application No. 63/709,117, filed on Oct. 18, 2024.

(51) Int. Cl. B23D 29/00; E04G 21/12

(52) U.S. Cl. CPC B23D 29/002; E04G 21/12

(57) ABSTRACT

A cable support apparatus for coupling a shearing apparatus to a cable includes a central spring pin, a first pivot pin, and a second pivot pin. The cable support apparatus further includes a first pivoting cable support member that includes a first cable notch and is configured to pivot about the first pivot pin. The cable support apparatus further includes a second pivoting cable support member that includes a second cable notch and is configured to pivot about the second pivot pin. The cable support apparatus further includes springs coupled to the central spring pin and the pivoting cable support members. The springs hold the pivoting cable support members in a closed position. When the pivoting cable support members are in the closed position, the cable notches collectively form a cable aperture that is shaped to at least partially surround the cable, thereby securing the shearing apparatus to the cable.

### PRIORITY

This application claims the benefit, under 35 U.S.C. § 119(e), of U.S. Provisional Ser. No. 63/709,177 , filed Oct. 18, 2024, the entirety of which is herein incorporated by reference for all purposes.

### TECHNICAL FIELD

This disclosure relates to tendons used in post-tensioning systems, and more particularly to methods and systems for in-pocket tendon shearing.

### BACKGROUND

Construction with concrete has been prevalent in both commercial and residential applications for more than a century. As construction methods have evolved, so has the composition and use of structural concrete.

Concrete has enormous compressive strength, but historically has needed beam construction to support tensile and lateral strength. While simple and economical, a post-and-beam structure, designed to support floors and/or roofs made of concrete slabs, are unsightly, and unnecessarily reduce usable square footage within the square footage of the concrete slab by taking up valuable space. Accordingly, various methods have been created to increase the tensile strength of concrete. One method of increasing the tensile strength of concrete has been to add rebar, or steel rods, within the concrete. However, this method is only marginally successful at increasing the tensile strength.

Two of the simpler and more effective slab-strengthening methods are pre-tensioning and post-tensioning. Pre-tensioning occurs in a controlled shop environment where strands of wire, or tendon, are stretched from end-to-end of a form, and then concrete is poured around the pre-stretched tendons. When the concrete cures, it adheres to the tendons, which provide compressive force along the axis of the tendon, thus increasing the tensile strength of the concrete slab.

Post-tensioning is a more cost effective and efficient method of reinforcing concrete slabs. In post-tensioning, a tendon is anchored at one end of a slab form—a fixed end—and is laid along an axis of the form in an unstressed state. The tendon is housed in a sheath, which allows the tendon to move freely within the sheath. In most cases, the tendon is surrounded by heavy grease to assist its longitudinal movement within the sheath. Concrete is then poured within the form surrounding the tendon. Once the concrete has been poured into the form (on the construction site), the tendon is tensioned with a jack at an anchor at the opposite end of the tendon from the fixed end. This second anchor is known as the “live end.” There may be one or more intermediate anchors within the slab, depending on the span covered by the tendon. Typically, strands of tendons are placed perpendicular to one another to tension the concrete slab along both a vertical and horizontal axis along the plane of the slab.

The benefits to post-tensioning are numerous. First, post-tensioning allows the slab to be formed and poured on site, ensuring that the form is exactly correct in its dimensions. Second, because the slab is poured on site, transportation costs are reduced because finished pre-tensioned slabs require extremely large vehicles to move them from shop to site. Additionally, but not exhaustively, pre-tensioning is dangerous in a shop environment, because thousands of pounds of force are applied to a pre-tensioned tendon with nothing to prevent it from harming workings in the event it snaps before the concrete is poured. In post-tensioning, the tendon is unstressed with the concrete is poured, so in the event of a tendon failure during tensioning, it is surrounded by a large amount of concrete, which prevents the tendon from whipping out of the form.

When the post-tensioning system is tensioned, a tail of tendon extends through the live-end anchor. Typically, a jack is affixed to the end of the tendon at a device called a pocket former. The pocket former ensures that once the concrete is poured, there is sufficient space to install the jack by preventing the ingress of concrete into the area where the tendon protrudes through the live-end anchor. Wedges are installed around the tail of the tendon, which will have no sheathing. The wedges typically have beveled “teeth” facing the tail end, such that when the tendon is released, the wedges in the anchor cavity seat, grab the tendon by biting into the metal cable strands, and prevent the tendon from retracting after tensioning. Once the desired tension is achieved, the tendon is cut as close to the anchor cavity as possible.

There are several ways to accomplish clipping of the tendon, such as via saws, torches, or specialized apparatuses. Saws can be dangerous, prone to kicking back at the operator, and additionally cannot sever the tendon within the pocket, leaving the end of the tendon protruding from the concrete and vulnerable to corrosion. Torches are also not ideal, as they can overheat the plastic and polymer materials associated with the tendon and accompanying anchors, leading to construction and corrosion problems. Because of these issues, a hydraulic or battery-powered cutting apparatus is often utilized to accomplish shearing of the tendon. However, hydraulic apparatuses require pumps to function, which can be unwieldy, heavy, and difficult to operate, especially for construction workers or engineers that need to clip tendons that are located dozens of stories above the ground. Battery-powered apparatuses, while not requiring a pump, do require dedicated batteries and motors to function, adding to the cost of the device. Further, generating enough pressure to clip tensioned tendons via such a battery-powered apparatus is extremely difficult, leading to poor battery life and frequent equipment failure.

### SUMMARY

In one embodiment, a shearing apparatus includes a torque conversion mechanism, a cutting nose, and a cable support. The torque conversion mechanism is operable to be coupled to a torque generator. The cutting nose is in operable connection with the torque conversion mechanism and is operable to sever a cable. The cable support is operable to removably couple the shearing apparatus to the cable. The cable support includes a central spring pin, a first pivot pin, and a second pivot pin. The cable support further includes a first pivoting cable support member that is configured to pivot about the first pivot pin and includes a first cable notch. The cable support further includes a first spring coupled to the central spring pin and the first pivoting cable support member. The cable support further includes a second pivoting cable support member that is configured to pivot about the second pivot pin and includes a second cable notch. The cable support further includes a second spring coupled to the central spring pin and the second pivoting cable support member. The first and second springs are configured to hold the first and second pivoting cable support members in a closed position. When the first and second pivoting cable support members are in the closed position, the first and second cable notches collectively form a cable aperture that is shaped to at least partially surround the cable, thereby securing the shearing apparatus to the cable.

In another embodiment, a cable support apparatus for coupling a shearing apparatus to a cable includes a central spring pin, a first pivot pin, and a second pivot pin. The cable support apparatus further includes a first pivoting cable support member that includes a first cable notch and is configured to pivot about the first pivot pin. The cable support apparatus further includes a second pivoting cable support member that includes a second cable notch and is configured to pivot about the second pivot pin. The cable support apparatus further includes springs coupled to the central spring pin and the pivoting cable support members. The springs hold the pivoting cable support members in a closed position. When the pivoting cable support members are in the closed position, the cable notches collectively form a cable aperture that is shaped to at least partially surround the cable, thereby securing the shearing apparatus to the cable.

In another embodiment, a method of shearing a cable in a concrete support system includes attaching a shearing apparatus to a cable using a cable support of the shearing apparatus. The cable support includes a central spring pin, a first pivot pin, and a second pivot pin. The cable support further includes a first pivoting cable support member that is configured to pivot about the first pivot pin and includes a first cable notch. The cable support further includes a first spring coupled to the central spring pin and the first pivoting cable support member. The cable support further includes a second pivoting cable support member that is configured to pivot about the second pivot pin and includes a second cable notch. The cable support further includes a second spring coupled to the central spring pin and the second pivoting cable support member. The first and second springs are configured to hold the first and second pivoting cable support members in a closed position. When the first and second pivoting cable support members are in the closed position, the first and second cable notches collectively form a cable aperture that is shaped to at least partially surround the cable, thereby securing the shearing apparatus to the cable. The method further includes severing the cable by applying torque to the shearing apparatus via a torque generator.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure and its advantages, reference is now made to the following descriptions taken in conjunction with the accompanying drawings, in which:

FIGS. 1A-1D illustrate perspective views of a shearing system in accordance with the principles of the present disclosure;

FIGS. 2A-2H illustrate perspective views of a shearing system, e.g., including a cable support, in accordance with the principles of the present disclosure; and

FIGS. 3A-3D illustrate perspective views of a torque conversion mechanism in accordance with the principles of the present disclosure.

FIGS. 4A-4B illustrate a dual spring cable support apparatus, according to certain embodiments.

FIGS. 5A-5J illustrate a dual turnstile cable support apparatus, according to certain embodiments.

FIG. 6 illustrates a turnstile with a cam-driven ratchet, according to certain embodiments.

FIG. 7 illustrates a dual turnstile cable support apparatus that includes turnstiles with gear-driven timing, according to certain embodiments.

FIG. 8 illustrates a dual turnstile cable support apparatus that includes turnstiles geared with a ratchet, according to certain embodiments.

FIG. 9 illustrates a dual turnstile cable support apparatus that includes turnstiles with double ratchets, according to certain embodiments.

FIG. 10 illustrates a dual turnstile cable support apparatus that includes turnstiles with turnstile springs, according to certain embodiments.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

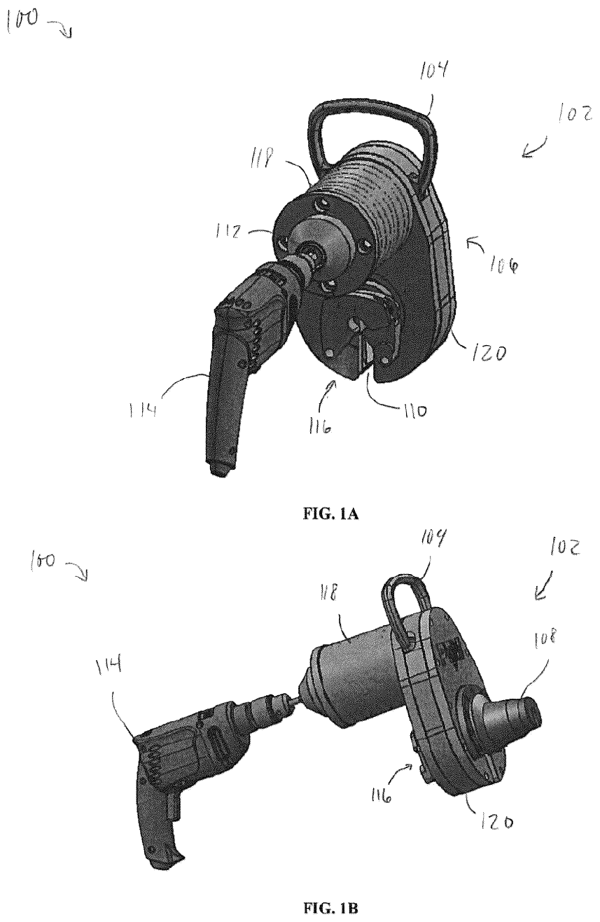

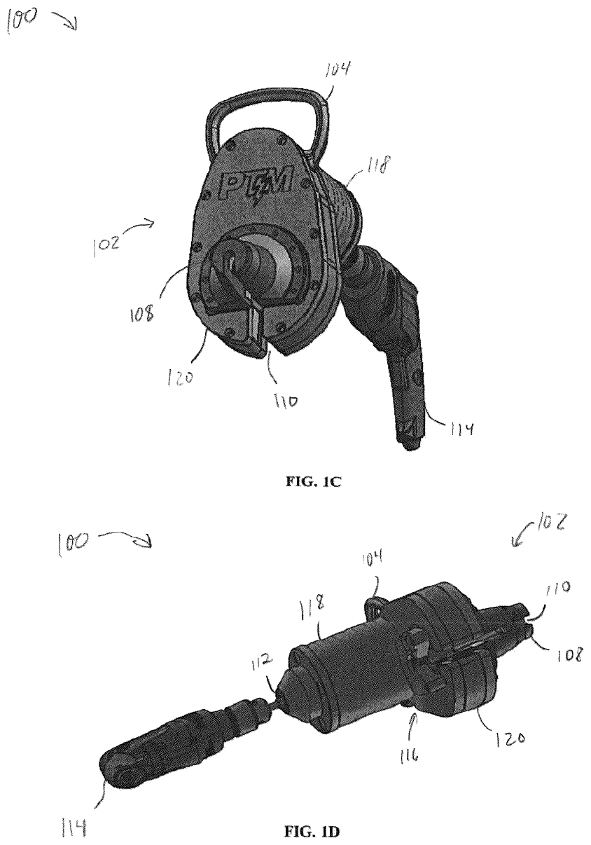

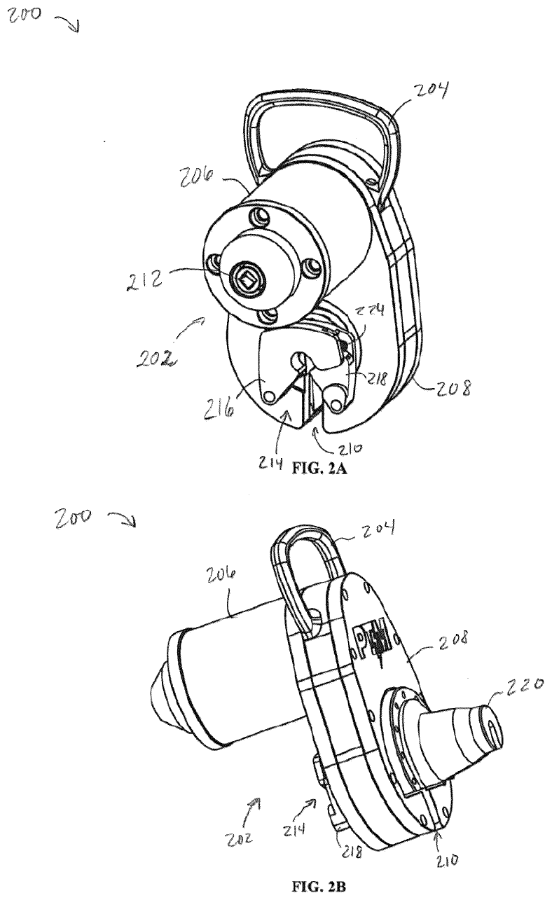

FIGS. 1A-1D depict one embodiment of the present disclosure. A shearing system 100 can include a shearing apparatus 102 and a torque generator 114. In one embodiment, the torque generator 114 can include any motorized or powered tool, such as power drills, electric screwdriving apparatuses, electric drills, impact drills, power saws, dremels, or any other power tool known in the art operable to generate and apply torque. In another embodiment, the torque generator can include a ratchet, wrench, crank, or any other device or apparatus suitable to generate torque or allow a user of the device to generate torque. Preferably, the torque generator is a drill apparatus 114. In an exemplary embodiment, the drill apparatus 114 can comprise an electric drill known in the art. The shearing apparatus 102 can include a handle 104, a casing 106, a cutting nose 108, a groove (cable groove) 110, and an adapter 112. The handle 104 can take any form suitable to enable a user of the apparatus 102 to grip the apparatus 102. In another embodiment, the handle 104 can take any form suitable to lend structure to the apparatus 102 and support the casing 106.

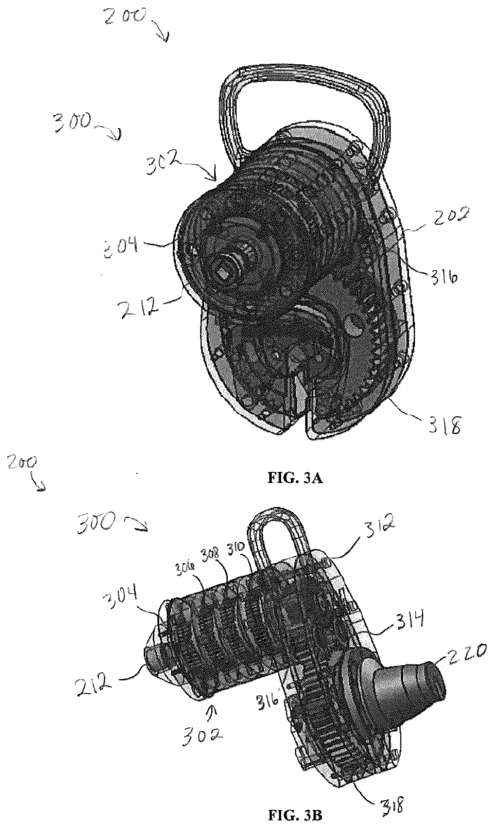

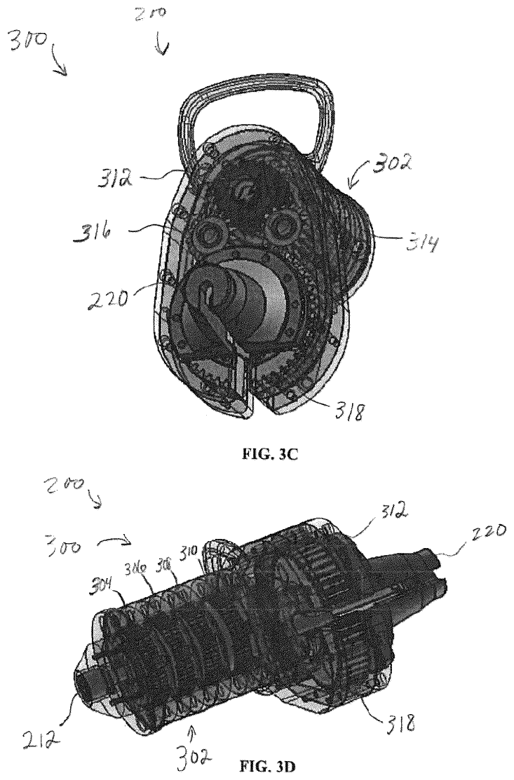

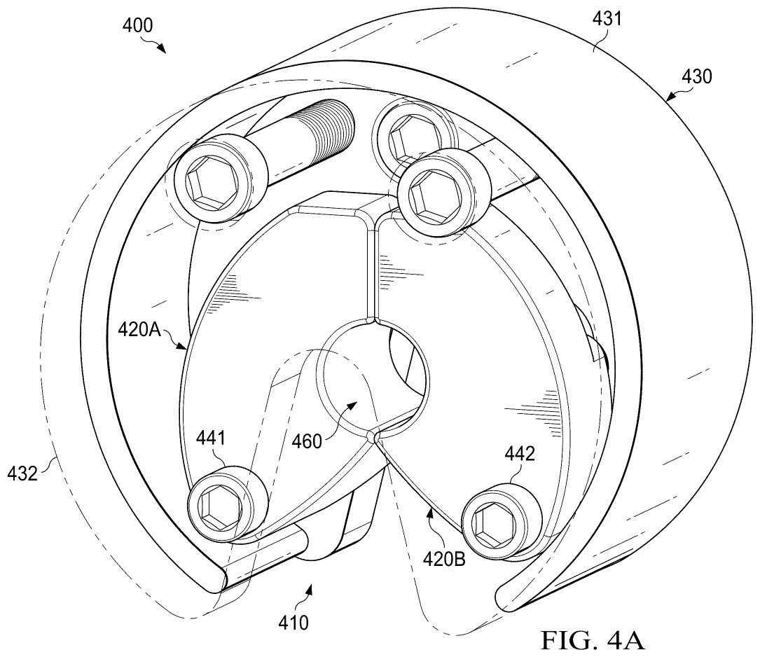

In one embodiment, the casing 106 can provide a main body to the apparatus 102 and can be operable to contain mechanisms (not shown in FIGS. 1A-1D) of the apparatus 102, such as the torque conversion apparatus or myriad of gears discussed with respect to FIGS. 3A-3D. The casing 106 can be fastened to the handle 104 and can further be configured to receive a cable via the cable groove 110. The casing 106 can additionally be coupled to the cutting nose 108, such that the nose 108 can protrude from the casing 106. In one example, the casing 106 can be a gearbox 106; in another example, the casing 106 can be a sphere, pyramid, or another other shape suitable to connect to the handle 104 and cutting nose 108 while casing mechanisms of the apparatus, such as those discussed in FIGS. 3A-3D. The casing 106 can also be configured to allow interaction with the mechanisms contained within the casing 106. For example, and as mentioned above, the casing 106 and cutting nose 108 can comprise recessed areas that together form a cable groove 110. The cable groove 110 can be of any size or shape suitable to receive a cable of any size. In this manner, and as an example, the casing 106 can be configured to allow mechanisms contained therein to interact with the cable, such as via the cable groove 110. As another example, the casing 106 can comprise one or more orifices from which an adapter 112 can protrude. In another embodiment, the adapter 112 can be contained within the casing 106, and a drill apparatus 114 can access the adapter 112 through a hole in the casing 106.

In another embodiment, the casing 106 can include a first member 118 and a second member 120. For example, the first member 118 can be operably coupled to the second member 120. In another example, the first member 118 can extend from the second member 120. In another example, the first member 118 can be configured to house a portion of a torque conversion mechanism in accordance with the principles of the present disclosure. For example, the first portion 118 can be configured to house epicyclic gearing or any other suitable gearing mechanism. In another example, the first member 118 can be substantially cylindrical, such as to minimize a profile of the first member 118 and accomplish housing of components of a torque conversion mechanism. In another embodiment, the second member 120 can be configured to house a different portion of a torque conversion mechanism. For example, the second member 120 can be configured to house a portion of a torque conversion mechanism, such as a sun gear, drive gear, and/or spur gear.

In one embodiment, the adapter 112 can be configured to engage mechanisms disposed within the casing 106 via turning of the adapter 112. As an example, the adapter 112 can be configured to engage a power drill/screwdriver, with any suitable wrench head attached thereto, and transfer torque generated from the drill/screwdriver to mechanisms disposed within the casing 106. In one embodiment, the adapter 112 can comprise a hexagonal wrench head, a flat head, or any other wrench head suitable to transfer torque from the torque generator. In this manner, and as an example, the casing 106 can be configured to allow interaction with the mechanisms within the casing 106. In another embodiment, the casing 106 can further include a cable support 116. For example, the cable support 116 can take the form of a latch operable to support a cable within the cable groove 110. In one embodiment, the support 116 can be “opened” via, for example, a hinge mechanism, and after a cable is engaged within the cable groove, the support 116 can be “closed” to offer support to the cable while it is within the groove 110. The support 116 can include any suitable mechanism to support the cable within the groove 110.

In one embodiment, the adapter 112 can interact with mechanisms disposed within the casing 106 to ultimately operate the cutting nose 108. For example, the nose 108 can protrude from the casing 106 such that the nose 108 can engage a cable within a pocket of a concrete support post-tensioning system. The nose 108 can include one or more blades (not shown in FIGS. 1A-1D) operable to sever a cable that is engaged within the cable groove 110 and cutting nose 108. As mentioned above, in one example, the nose 108 can be configured to fit within a pocket of a concrete support post-tensioning system such that the blades of the nose 108 can clip the cable within the pocket. In another embodiment, applying torque to the adapter 112 can initiate mechanisms disposed within the casing 106 that are in operable connection with the cutting nose 108 to engage a blade or blades of the nose 108 to facilitate shearing of the cable. In another embodiment, the cutting nose 108 can comprise a static blade and a rotating blade. In another embodiment, the cutting nose 108 can comprise any number of static blades and/or mobile blades to accomplish the shearing of a cable. In another embodiment, the cutting nose 108 can take the form of any cutting nose known in the art.

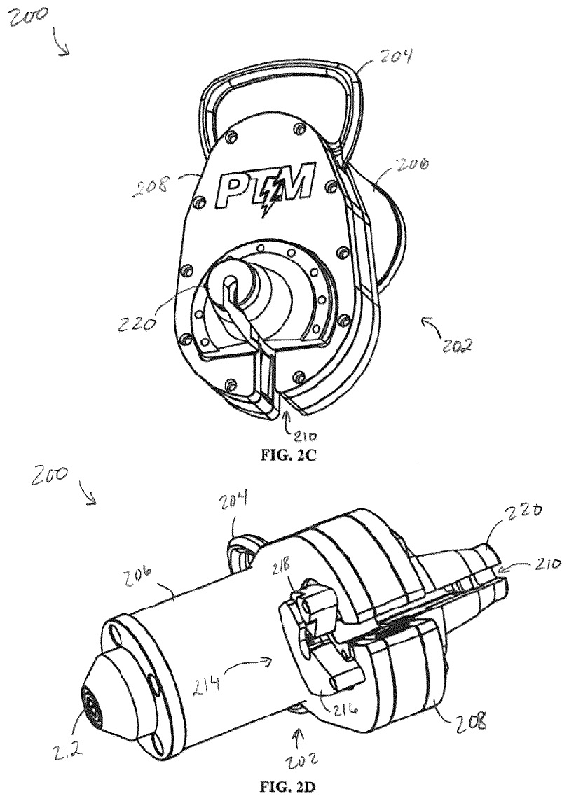

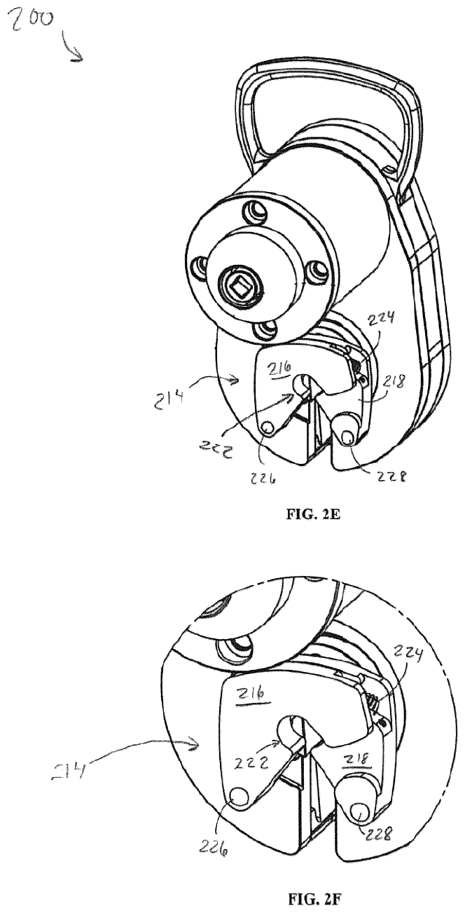

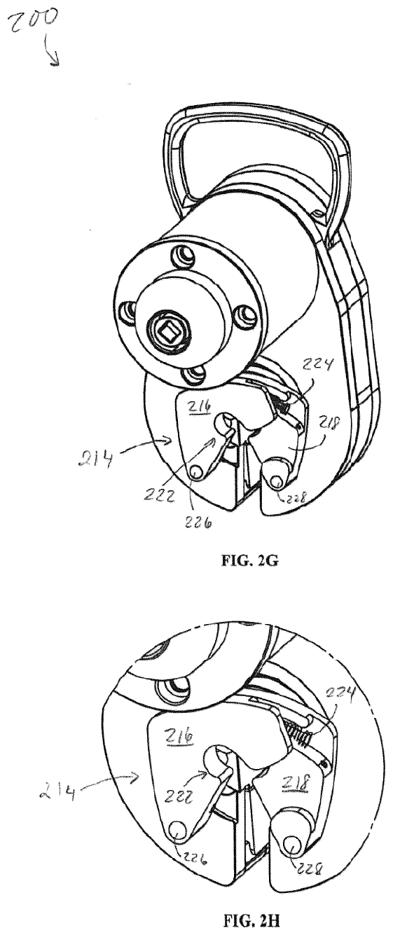

FIGS. 2A-2H depict one embodiment of the present disclosure. A shearing apparatus 200 can include a handle 204, a casing 202, a cutting nose 220, a groove (cable groove) 210, and an adapter 212. The handle 204 can take any form suitable to enable a user of the apparatus 200 to grip the apparatus 200. In another embodiment, the handle 204 can take any form suitable to lend structure to the apparatus 200 and support the casing 202. In one embodiment, the casing 202 can provide a main body to the apparatus 200 and can be operable to contain mechanisms (not shown in FIGS. 1A-1D) of the apparatus 200, such as the torque conversion apparatus or myriad of gears discussed with respect to FIGS. 3A-3D. The casing 202 can be fastened to the handle 204 and can further be configured to receive a cable via the cable groove 210. The casing 202 can additionally be coupled to the cutting nose 220, such that the nose 220 can protrude from the casing 202. In one example, the casing 202 can be a gearbox 202; in another example, the casing 202 can be a sphere, pyramid, or another other shape suitable to connect to the handle 204 and cutting nose 220 while casing mechanisms of the apparatus, such as those discussed in FIGS. 3A-3D. The casing 202 can also be configured to allow interaction with the mechanisms contained within the casing 202. For example, and as mentioned above, the casing 202 and cutting nose 220 can comprise recessed areas that together form a cable groove 210. The cable groove 210 can be of any size or shape suitable to receive a cable of any size. In this manner, and as an example, the casing 202 can be configured to allow mechanisms contained therein to interact with the cable, such as via the cable groove 210. As another example, the casing 202 can comprise one or more orifices from which an adapter 212 can protrude. In another embodiment, the adapter 212 can be contained within the casing 202, and a drill apparatus 114 can access the adapter 212 through a hole in the casing 202.

In another embodiment, the casing 202 can include a first member 206 and a second member 208. For example, the first member 206 can be operably coupled to the second member 208. In another example, the first member 206 can extend from the second member 208. In another example, the first member 206 can be configured to house a portion of a torque conversion mechanism in accordance with the principles of the present disclosure. For example, the first portion 206 can be configured to house epicyclic gearing or any other suitable gearing mechanism. In another example, the first member 206 can be substantially cylindrical, such as to minimize a profile of the first member 206 and accomplish housing of components of a torque conversion mechanism. In another embodiment, the second member 208 can be configured to house a different portion of a torque conversion mechanism. For example, the second member 208 can be configured to house a portion of a torque conversion mechanism, such as a sun gear, drive gear, and/or spur gear. In one embodiment, the adapter 212 can be configured to engage mechanisms disposed within the casing 202 via turning of the adapter 212. As an example, the adapter 212 can be configured to engage a power drill/screwdriver, with any suitable wrench head attached thereto, and transfer torque generated from the drill/screwdriver to mechanisms disposed within the casing 202. In one embodiment, the adapter 212 can comprise a hexagonal wrench head, a flat head, or any other wrench head suitable to transfer torque from the torque generator. In this manner, and as an example, the casing 202 can be configured to allow interaction with the mechanisms within the casing 202.

In another embodiment, the casing 202 can further include a cable support 214. For example, the cable support 214 can take the form of a latch 214 operable to support a cable within the cable groove 210. In one example, the support 214 can include a first member 216 and a second member 218. In another embodiment, the support 214 can include a spring 224 operable to mediate movement of the first member 216, the second member 218, or both. In another embodiment, the support 214 can be configured to receive a cable. For example, the support 214 can include an aperture 222 sized to circumscribe a cable. In another embodiment, the aperture 222 can be configured to expand or contract. For example, the first and/or second members 216, 218 can be coupled to the casing 202 via pins 226, 228, such that the first and/or second member 216, 218 can be hingedly attached to the casing 202. In another example, a spring 224 can be operably coupled with the first and/or second member 216, 218 such that expansion and/or contraction of the aperture 222 can be mediated by the spring 224. In one embodiment, and as illustrated in FIGS. 2G-2H, the support 214 can be “opened” via, for example, a hinge mechanism of one or both of the first or second member 216, 218, and after a cable is engaged within the cable groove, the support 214 can be “closed” (as illustrated in FIGS. 2E-2F) to offer support to the cable while it is within the groove 210. In another example, the spring 224 can be configured to maintain the support 214 in a “closed” configuration, such as via spring 224, and the support 214 can be further configured to achieve an “opened” position as a force is applied against the first and/or second member 216, 218 towards the aperture 222. In another example, the first and/or second member 216, 218 can be sloped towards the aperture 222, such as to facilitate the placement of a cable within the aperture 222.

In one embodiment, the support 214 can be configured to facilitate the removable coupling of a cable within the aperture 222 and/or cable groove 210. For example, the apparatus 200 can be lowered onto a cable while the support 214 is in a closed position. In another example, the support 214 can receive a cable between, e.g., the first and second members 216, 218, and as the apparatus 200 is lowered onto a cable, the first and second members 216, 218 can be pushed outwards from the cable, expanding the aperture 222, such that the cable can travel into the aperture 222. In another embodiment, once the cable is within the aperture 222, the spring 224 can cause the aperture 222 to contract, such as by mediating movement of the first and/or second member 216, 218. In another example, the support 214 and/or latch 214 can include any number of members suitable to facilitate the securing of a cable within the cable groove 210. In another embodiment, the support 214 can include any suitable mechanism to support the cable within the groove 210, such as latches, ties, supports, wedges, hooks, rings, attachment mechanisms, coupling mechanisms, or any other mechanism(s) suitable to facilitate the securing and/or removable coupling of a cable within the cable groove 210.

In one embodiment, the adapter 212 can interact with mechanisms disposed within the casing 202 to ultimately operate the cutting nose 220. For example, the nose 220 can protrude from the casing 202 such that the nose 220 can engage a cable within a pocket of a concrete support post-tensioning system. The nose 220 can include one or more blades (not shown in FIGS. 1A-1D) operable to sever a cable that is engaged within the cable groove 210 and cutting nose 220. As mentioned above, in one example, the nose 220 can be configured to fit within a pocket of a concrete support post-tensioning system such that the blades of the nose 220 can clip the cable within the pocket. In another embodiment, applying torque to the adapter 212 can initiate mechanisms disposed within the casing 202 that are in operable connection with the cutting nose 220 to engage a blade or blades of the nose 220 to facilitate shearing of the cable. In another embodiment, the cutting nose 220 can comprise a static blade and a rotating blade. In another embodiment, the cutting nose 220 can comprise any number of static blades and/or mobile blades to accomplish the shearing of a cable. In another embodiment, the cutting nose 220 can take the form of any cutting nose known in the art.

FIGS. 3A-3D depict another embodiment of the present disclosure. A torque conversion mechanism 300 can be included in a shearing apparatus 200. In one embodiment, the torque conversion mechanism 300 can include at least one gear. In one embodiment, casing 202 of the shearing apparatus 200 can contain the mechanism 300, and in one embodiment, the mechanism 300 can utilize torque generated at and transferred from the adapter 212 to facilitate operation of the cutting nose 220. In one embodiment, the mechanism 300 within the casing 202 can include epicyclic gearing (epicyclic gear train) (planetary gearset) 302. For example, epicyclic gearing 302 can be included in the first member of the casing 202. In another embodiment, epicyclic gearing 302 can include one or more planetary gear trains 304, 306, 308, 310 operably engaged with the adapter 212. For example, the adapter 212 can be operably coupled with a first sun gear 304, and the first sun gear 304 can be operably engaged with the first planetary gear train 304, such that turning of the adapter 212 can thereby turn the first sun gear 304 and consequently turn the first planetary gear train 304. In one embodiment, each of the planetary gear trains 304, 306, 308, 310 can include one or more sun gears, one or more planet gears, one or more carriers, and/or one or more ring gears (annular gears). In another embodiment, each of the planetary gear trains 304, 306, 308, 310 can be engaged with one or more other components of the torque conversion mechanism 300.

In another embodiment, the epicyclic gearing 302 can include a second sun gear 312. For example, the second sun gear 312 can be engaged with one or more of the planetary gear trains 304, 306, 308, 310. In another embodiment, the second sun gear 312 can be engaged with at least one spur gear 314, 316. In another embodiment, the at least one spur gear 314, 316 can be engaged with a drive gear 318. For example, the drive gear 318 can be configured to engage with the at least one spur gear 314, 316 and facilitate operation of the cutting nose 220. In another embodiment, the mechanism 300 can include any number and/or configuration of gears, levers, etc. suitable to utilize torque generated at the adapter 212 to mobilize blades of the cutting nose 220.

In one embodiment, the mechanism 300 can include a stopping mechanism, such as to prevent over-rotation of the mechanism 300. For example, the drive gear 318 can include a nub, a peg, a rod, corrugation, etc. that can facilitate prevention of over-rotation. For example, protrusion from the drive gear 318 can engage a channel on the interior of the casing 202, such that the movement of the drive gear 318 can be limited by the size and/or length of the channel. In another example, the stopping mechanism can be a timing channel. In another example, the stopping mechanism can utilize any gear of the mechanism 300 to prevent over-rotation of one or more gears of the mechanism 300. In another embodiment, the mechanism 300 can be configured to utilize torque applied from either direction to operate the cutting nose 220. For example, the mechanism 300 can be configured to utilize clockwise-torque and/or counter-clockwise-torque to sever a cable within the nose 220.

Principles of the present disclosure can be utilized to facilitate clipping of, e.g., the live end of a cable in a post-tensioning system. In another embodiment, a shearing apparatus (e.g., 200) and/or system in accordance with the principles of the present disclosure can be used to sever any other cable, tendon, strand, line, chain, rope, or other suitable substrate. In another embodiment, the present disclosure can offer several advantages. For example, the mechanism 300 can be capable of facilitating the dissipation of heat from the mechanism 300. In one example, the epicyclic gearing 302 can facilitate airflow throughout the apparatus 200 that can participate in heat dissipation. In another embodiment, the principles of the present disclosure can enhance the fidelity of cable shearing. For example, cables can be, e.g., left-hand-braided or right-hand-braided, and cutting a braided cable from the wrong direction can lead to fraying, unwinding, and/or general comprise of cable integrity. In one embodiment, a shearing apparatus in accordance with the principles of the present disclosure can apply a blade of a cutting nose from one direction according to the direction of torque receive at an adapter of the apparatus. For example, counter-clockwise torque applied at the adapter can correspond to causing a blade of the cutting nose to approach a cable held therein from the right side of the cable (e.g., when looking from the adapter of the apparatus to the nose of the apparatus); in another embodiment, clockwise torque can cause a blade of the cutting nose to approach the cable from the opposite direction. In another embodiment, blades of the cutting nose can approach the cable from any suitable direction, and the direction of the torque at the adapter can determine an approach of the blades of the nose.

The present disclosure offers several advantages:
Providing a portable, user-friendly apparatus operable to shear cables in a concrete support system without the use of hydraulics or dedicated batteries;
Providing a new use for existing power tools, such as power drills and screwdrivers;
Providing a system that can utilize manual or powered torque to accomplish cable shearing;
Increasing construction site and tool efficiency by obviating the need for dedicated, powered devices for cable shearing;
Converting torque from, for example, a power drill to pressure for cable shearing;
Providing a shearing apparatus that can shear a cable using clockwise and/or counter-clockwise torque; and
Providing a shearing apparatus that can shear a cable from different directions, such as depending on a braid or weave of the cable.

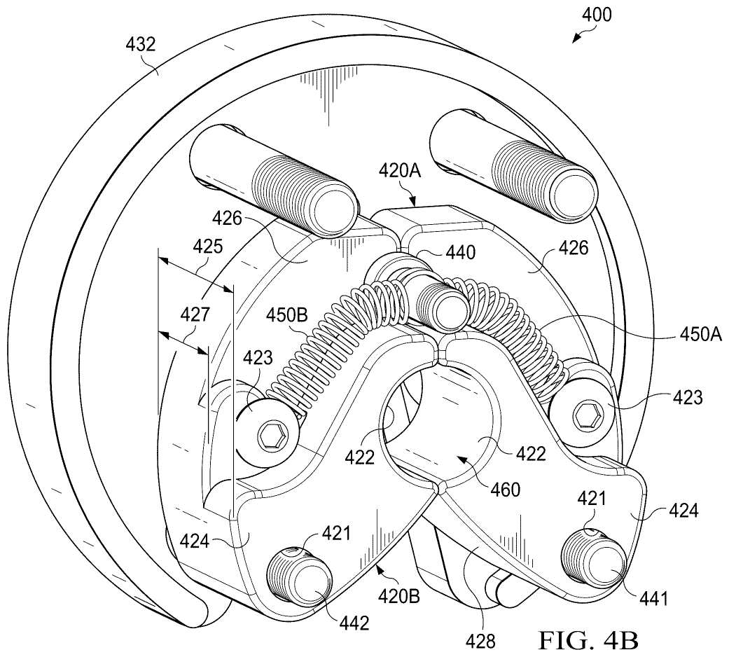

FIGS. 4A-4B illustrate a dual spring cable support 400 that may be used as cable support 116 or cable support 214 to secure any appropriate apparatus (e.g., shearing apparatus 102, shearing apparatus 200, etc.) to a cable, according to certain embodiments. Dual spring cable support 400 includes two pivoting cable support members 420 (a first pivoting cable support member 420A and a second pivoting cable support member 420B) and a housing 430. A portion of housing 430 and pivoting cable support members 420 form a cable groove 410, which is shaped to guide a cable into cable aperture 460 that is formed by pivoting cable support members 420, thereby securing dual spring cable support 400 to the cable.

In general, dual spring cable support 400 includes first pivoting cable support member 420A and second pivoting cable support member 420B that are housed either partially or fully inside housing 430. Pivoting cable support members 420 each include a cable notch 422 that forms a portion of a cable aperture 460. Pivoting cable support members 420 are held in the closed position (as illustrated in FIGS. 4A and 4B) via springs 450. When a cable is forced upwards (i.e., towards cable aperture 460) against one or both of pivoting cable support members 420, pivoting cable support members 420 and springs 450 are forced apart, thereby increasing the size of cable aperture 460 and permitting the cable to move inside cable aperture 460. Once the cable is fully within cable aperture 460, the forces provided by springs 450 cause pivoting cable support members 420 to pivot back to the closed position, thereby capturing the cable within cable aperture 460 and preventing the cable from exiting cable aperture 460. As a result, dual spring cable support 400 may be easily and quickly secured to the cable without requiring the use of any external tools or fasteners.

In some embodiments, dual spring cable support 400 includes two pivoting cable support members 420: first pivoting cable support member 420A and second pivoting cable support member 420B. In general, pivoting cable support members 420 pivot within dual spring cable support 400 in order to capture and secure a cable within cable aperture 460. In some embodiments, each pivoting cable support member 420 includes a pivoting pin aperture 421 that is used to pivotably couple the pivoting cable support member 420 to housing 430 via a pivot pin. For example, first pivoting cable support member 420A is pivotably coupled to housing 430 via first pivot pin 441, and second pivoting cable support member 420B is pivotably coupled to housing 430 via second pivot pin 442.

In some embodiments, each pivoting cable support member 420 is coupled to a spring 450 that is attached to a central spring pin 440. For example, first pivoting cable support member 420A is coupled to a first spring 450A that is coupled to central spring pin 440, and second pivoting cable support member 420B is coupled to a second spring 450B that is coupled to central spring pin 440. Each spring 450 is coupled to its respective pivoting cable support member 420 at a spring attachment location 423 using any appropriate fastener (e.g., screw, bolt, pin, rivet, etc.).

In some embodiments, each pivoting cable support members 420 includes a stepped profile as illustrated in FIGS. 4A and 4B. In these embodiments, each pivoting cable support member 420 includes a first stepped profile portion 424 that has a first thickness 425, and a second stepped profile portion 426 that has a second thickness 427. In some embodiments, second thickness 427 is less than first thickness 425 in order to provide clearance for springs 450 and spring attachment locations 423. Furthermore, first thickness 425 may be greater than second thickness 427 in order to provide an adequate surface area for cable aperture 460 so that dual spring cable support 400 remains stable while coupled to a cable.

In some embodiments, each pivoting cable support members 420 includes a cable notch 422. Each cable notch 422, in general, forms a portion of cable aperture 460. In some embodiments, each cable notch 422 is semi-circular in shape as illustrated. When pivoting cable support members 420 are in the closed position as illustrated in FIGS. 4A and 4B, cable notches 422 of pivoting cable support members 420 collectively form cable aperture 460 that is shaped to at least partially surround a cable.

In some embodiments, each pivoting cable support members 420 includes a cable groove edge 428. In general, cable groove edges 428 of pivoting cable support members 420 collectively form a “V” or wedge shape that functions, along with cable groove 410, to guide a cable into cable aperture 460. In operation, a cable is pressed against one or both cable groove edges 428 in order to cause pivoting cable support members 420 to pivot away from each other, thereby increasing the size of cable aperture 460 and permitting the cable to move into cable aperture 460.

Housing 430 is any appropriate cover or casing for dual spring cable support 400. In some embodiments, housing 430 includes a first housing section 431 and a second housing section 432. First housing section 431 may be coupled to second housing section 432 using any appropriate number and type of fasteners. In some embodiments, first pivot pin 441 and second pivot pin 442 are used to couple first housing section 431 and second housing section 432 together. Housing 430 may have any appropriate shape (e.g., circular, as illustrated) and may be formed from any appropriate material such as metal. In some embodiments, housing 430 includes a cable groove 410 that functions, along with cable groove edges 428, to guide a cable into cable aperture 460. In some embodiments, cable groove 410 includes a “V” or wedge shape as illustrated.

In some embodiments, dual spring cable support 400 includes a central spring pin 440. In general, central spring pin 440 provides a central location within housing 430 for attaching springs 450. In some embodiments, central spring pin 440 is only attached to one side of housing 430. For example, central spring pin 440 may only be attached to first housing section 431 and not second housing section 432, as illustrated in FIGS. 4A and 4B. In these embodiments, central spring pin 440 does not extend the full width of housing 430. In other embodiments, central spring pin 440 extends then entire width of housing 430, similar to first pivot pin 441 and second pivot pin 442. In these embodiments, second stepped profile portions 426 of pivoting cable support members 420 may be notched or shaped in order to avoid contact with central spring pin 440.

Dual spring cable support 400 includes two springs 450: a first spring 450A and a second spring 450B. First spring 450A is coupled to central spring pin 440 and first pivoting cable support member 420A. Second spring 450B is coupled to central spring pin 440 and second pivoting cable support member 420B. Springs 450 are configured to hold pivoting cable support members 420 in the closed position as illustrated in FIGS. 4A and 4B.

In operation of dual spring cable support 400, a cable (e.g., cable 501) is placed within cable groove 410 and in contact with one or more cable groove edges 428 of pivoting cable support members 420. The cable is then pushed against one or more pivoting cable support members 420 in order to cause pivoting cable support members 420 to pivot away from each other and to expand springs 450. The cable is pushed against pivoting cable support members 420 with enough force to expand cable aperture 460 wide enough to permit the cable to enter cable aperture 460. Once the cable has fully entered cable aperture 460, the forces provided by expanded springs 450 cause pivoting cable support members 420 to pivot back to their original, closed positions. This causes the cable to be captured within cable aperture 460 formed by cable notches 422, thereby securing dual spring cable support 400 to the cable. As a result, dual spring cable support 400 may be easily and quickly secured to the cable without requiring the use of any external tools or fasteners.

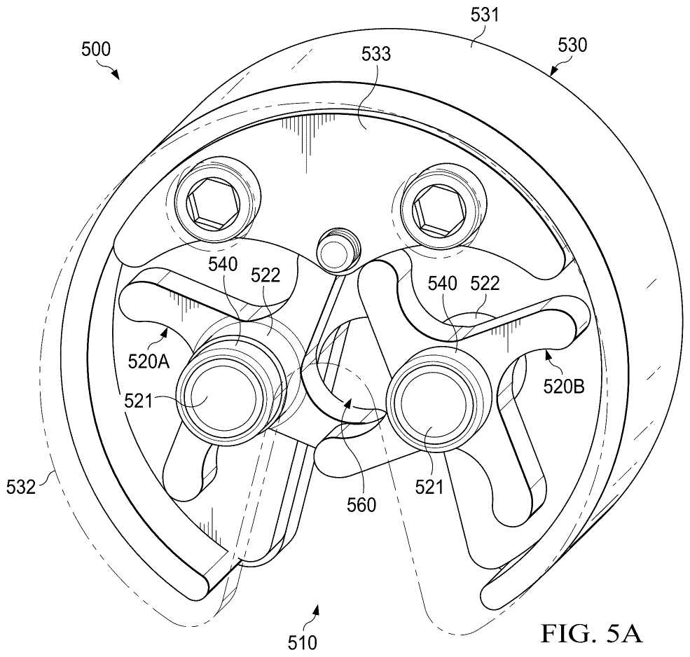

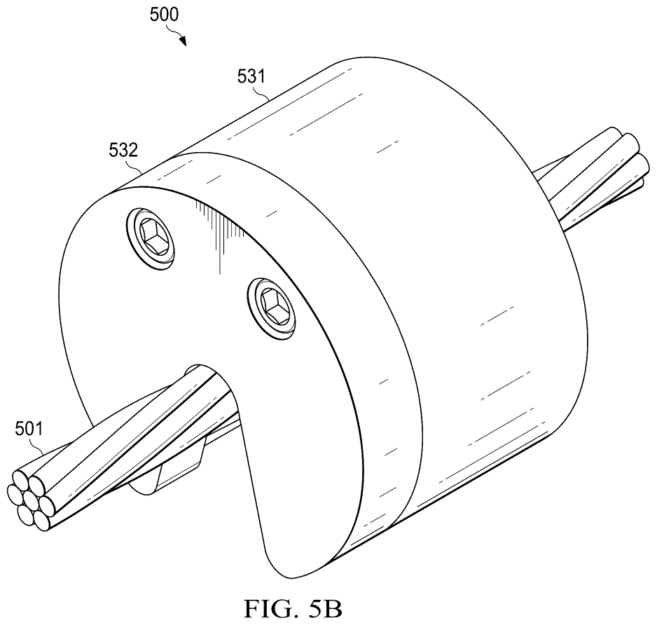

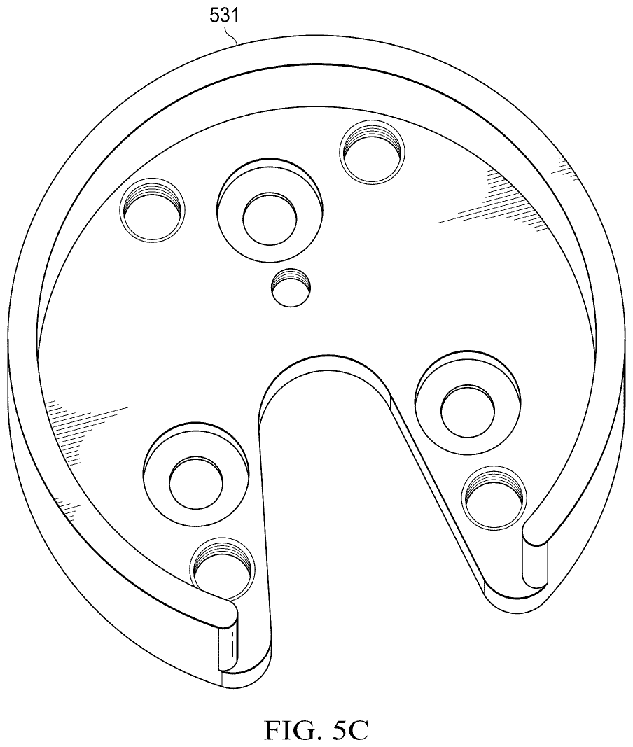

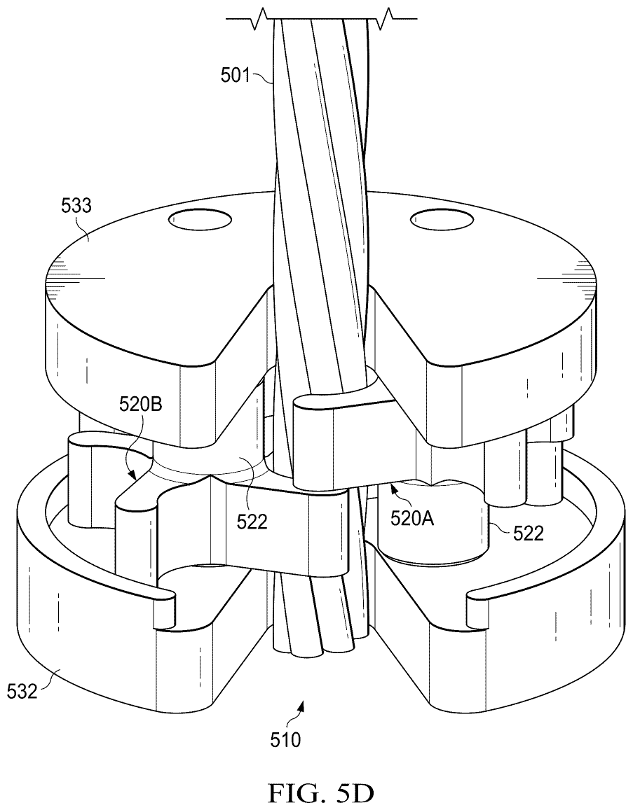

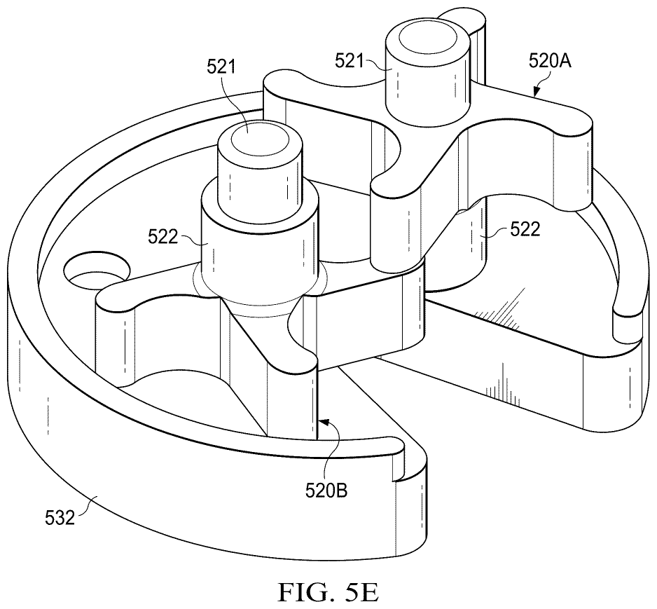

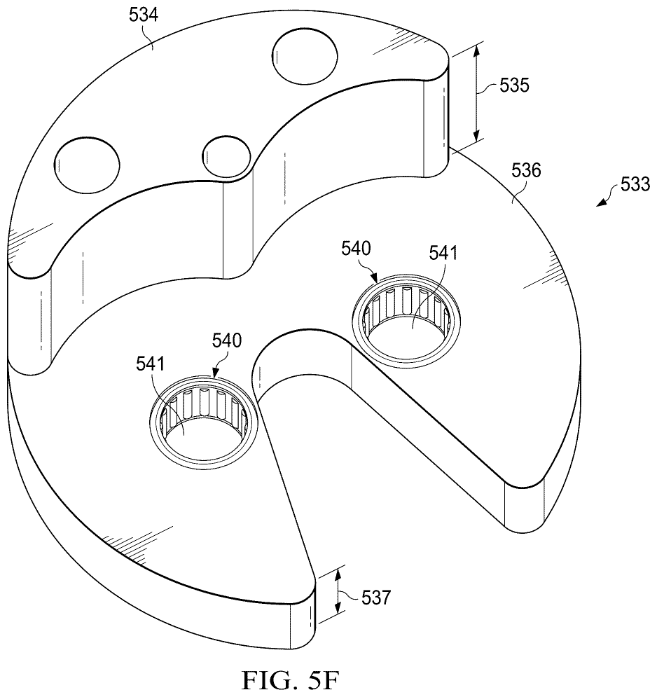

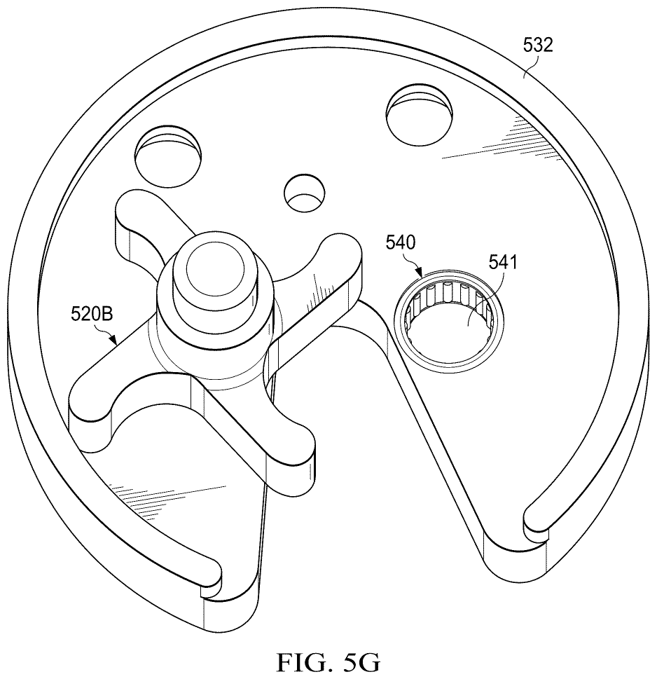

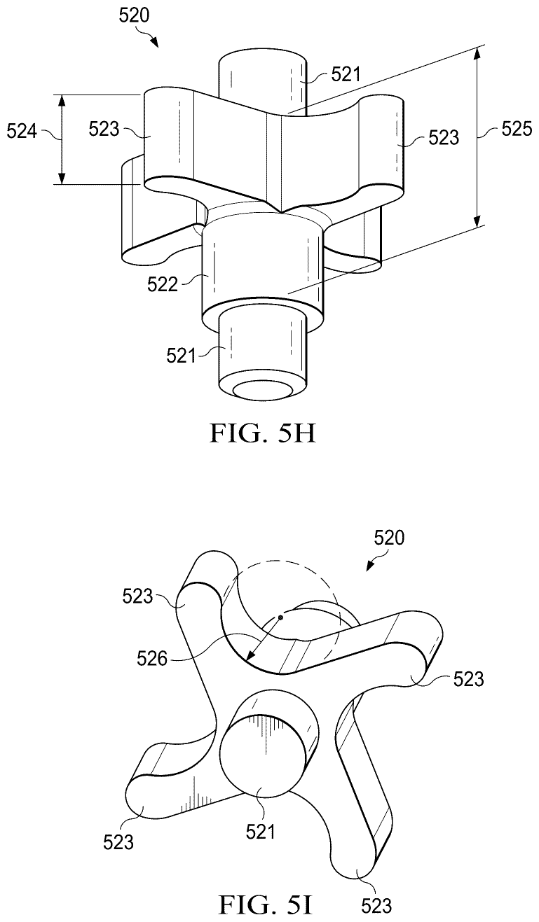

FIGS. 5A-5J illustrate a dual turnstile cable support 500 that may be used as cable support 116 or cable support 214 to secure any appropriate apparatus (e.g., shearing apparatus 102, shearing apparatus 200, etc.) to a cable, according to certain embodiments. Dual turnstile cable support 500 includes two turnstiles 520 (i.e., a first turnstile 520A and a second turnstile 520B), and a housing 530. A portion of housing 530 forms a cable groove 510, which is shaped to guide a cable 501 into cable aperture 560 that is formed by portions of turnstiles 520, thereby securing dual turnstile cable support 500 to cable 501.

In general, dual turnstile cable support 500 includes first turnstile 520A and second turnstile 520B that are housed either partially or fully inside housing 530. Turnstiles 520 each include multiple blades 523 (e.g., four blades 523) that form a portion of a cable aperture 560. One or both of turnstiles 520 are configured to only rotate in one direction by one or more one-way locking bearing clutches 540. When cable 501 is forced upwards (i.e., towards cable aperture 560) against blades 523 of one or both of turnstiles 520, turnstiles 520 rotate, thereby permitting cable 501 to enter cable aperture 560. Once cable 501 is fully within cable aperture 560, one or both of turnstiles 520 are prevented from rotating in the opposite direction by one or more one-way locking bearing clutches 540, thereby capturing cable 501 within cable aperture 560 and preventing cable 501 from exiting cable aperture 560. As a result, dual turnstile cable support 500 may be easily and quickly secured to cable 501 without requiring the use of any external tools or fasteners.

In some embodiments, turnstiles 520, which are illustrated best in FIGS. 5G-5I, include two or more (e.g., four) blades/protrusions 523 that extend off of a central hub 522. Each turnstile 520 includes a central shaft 521 that may be cylindrical in shape as illustrated. In some embodiments, central hub 522 has a larger diameter than central shaft 521. In some embodiments, as illustrated in FIG. 5H, blades 523 have a thickness 524 that is less than a thickness 525 of central hub 522. That is, blades 523 do not extend the full thickness 525 of central hub 522 in some embodiments.

In some embodiments, each blade 523 includes a curved shape as illustrated in FIG. 5I. In some embodiments, the curved shape may be defined by a radius 526 that is sized according to a diameter of cable 501. This curved shape may form a portion of cable aperture 560 and may help form a more secure attachment to cable 501.

As illustrated in FIGS. 5B-5F, some embodiments of dual turnstile cable support 500 include a housing 530. In some embodiments, housing 530 includes three separate components that are coupled together via fasteners: a first housing section 531, a second housing section 532, and an internal housing section 533. In general, first housing section 531, second housing section 532, and internal housing section 533 may be formed from any appropriate material such as metal. In some embodiments, first housing section 531, second housing section 532, and internal housing section 533 are each generally circular in shape. In some embodiments, first housing section 531 and second housing section 532 have the same overall diameter while second housing section 532 has a smaller diameter in order to be confined within first housing section 531. In some embodiments, first housing section 531, second housing section 532, and internal housing section 533 each include cutouts to form cable groove 510 that functions to guide cable 501 into cable aperture 560. In some embodiments, cable groove 510 includes a “V” or wedge shape as illustrated.

In some embodiments, internal housing section 533 includes a stepped profile as illustrated in FIG. 5F. In these embodiments, internal housing section 533 includes a first stepped profile portion 534 that has a first thickness 535 and a second stepped profile portion 536 that has a second thickness 537. In some embodiments, second thickness 537 is less than first thickness 535. In some embodiments, first stepped profile portion 534 has a scalloped shape as illustrated in order permit turnstiles 520 to rotate. In general, first stepped profile portion 534 is thicker than second stepped profile portion 536 in order to provide strength and stability to dual turnstile cable support 500. In some embodiments, first thickness 535 is equal to thickness 525 of central hub 522.

In some embodiments, second housing section 532 and internal housing section 533 each include multiple bearing seats 541 for housing one-way locking bearing clutches 540 or any other bearings. In some embodiments, bearing seats 541 are round cutouts within second housing section 532 and internal housing section 533 as illustrated. For example, second housing section 532 and internal housing section 533 may each include two bearing seats 541—one bearing seat 541 for each end of turnstiles 520A and 530B.

As illustrated in FIGS. 5D and 5E, a single blade 523 from a first turnstile 520A and a single blade 523 from a second turnstile 520B may combine to capture cable 501 within cable aperture 560, in some embodiments. As illustrated in FIGS. 5D and 5E, however, blades 523 from first turnstile 520A and second turnstile 520B do not overlap in a longitudinal direction along cable 501, in some embodiments. To accomplish this, a single design of turnstile 520 as illustrated in FIG. 5H may be used for both first turnstile 520A and second turnstile 520B but the turnstiles 520 are installed in opposite orientations. That is, first turnstile 520A may be installed with the portion of its central hub 522 without any blades 523 oriented towards second housing section 532 while second turnstile 520B may be installed with the portion of its central hub 522 without any blades 523 oriented towards internal housing section 533. In these embodiments, the portion of the central hub 522 of first turnstile 520A without any blades 523 contacts second housing section 532, and the portion of the central hub 522 of second turnstile 520B without any blades 523 contacts internal housing section 533.

In some embodiments, one or both of turnstiles 520 are only able to rotate in a single direction, thereby capturing cable 501 within cable aperture 560. To prevent turnstiles 520 from rotating in both directions, some embodiments of dual turnstile cable support 500 utilize one or more one-way locking bearing clutches 540 (also known as a drawn-cup roller clutch). A particular one-way locking bearing clutch 540 may be the 6392K43 One-Way Locking Needle-Roller Bearing Clutch from McMaster-Carr as illustrated in FIG. 5J. Bearings such as these include clutch rollers 542 that roll freely in one direction but lock (using, e.g., springs and wedges) to transmit torque when the rotation of the shaft is reversed.

In some embodiments, one-way locking bearing clutches 540 may have a maximum torque rating (e.g., approximately 4 ft.-lbs.) that is selected for particular applications. In some embodiments, a single one-way locking bearing clutch 540 may be utilized for each of turnstiles 520A and 530B and may configure each turnstile 520 to only rotate in one direction. In other embodiments, a single one-way locking bearing clutch 540 may be used for only one of turnstiles 520A and 520B (i.e., only one turnstile 520 may be prevented from rotating in both directions while the other turnstile 520 can freely rotate in both directions). In still other embodiments, a one-way locking bearing clutch 540 may be used for each end of both turnstiles 520A and 520B (e.g., two one-way locking bearing clutches 540 may be used for turnstile 520A and two one-way locking bearing clutches 540 may be used for turnstile 520B for a total of four one-way locking bearing clutches 540). In embodiments that utilize four one-way locking bearing clutches 540, each turnstile 520 may include a one-way locking bearing clutch 540 that surrounds the central shaft 521 of the turnstile 520 on each side of the blades 523 of the turnstile 520. In some embodiments, one-way locking bearing clutches 540 and/or central shafts 521 of turnstiles 520 are housed in bearing seats 541 of various components of housing 530 as illustrated.

In addition, turnstiles 520A-B may rotate in opposite directions (e.g., turnstile 520A only rotates in a counter-clockwise direction as viewed in FIG. 5A, and turnstile 520B only rotates in a clockwise direction as viewed in FIG. 5A). By utilizing one or more one-way locking bearing clutches 540, dual turnstile cable support 500 may be more robust and durable than embodiments that utilize springs such as springs 450 (e.g., less likely to fail, easier to repair, etc.). In addition, dual turnstile cable support 500 may provide a more positive capture of cable 501 because of the relative motion of turnstiles 520A-B to one another.

In operation of dual turnstile cable support 500, a cable 501 is placed within cable groove 510 and in contact with one or more blades 523 of turnstiles 520. Cable 501 is then pushed against the one or more blades 523 with enough force to cause turnstiles 520 to rotate. For example, turnstile 520A may be caused to rotate in a counter-clockwise direction as viewed in FIG. 5A, and turnstile 520B may be caused to rotate in a clockwise direction as viewed in FIG. 5A. The rotation of turnstiles 520 causes the contacted blades 523 to rotate out of the path of cable 501, thereby permitting cable 501 to enter cable aperture 560. Once cable 501 has fully entered cable aperture 560, subsequent blades 523 of turnstiles 520 have rotated into a position below cable 501. One or both of turnstiles 520 are prevented from rotating in the opposite direction by one or more one-way locking bearing clutches 540, thereby capturing cable 501 within cable aperture 560 and securing dual turnstile cable support 500 to cable 501. As a result, dual turnstile cable support 500 may be easily and quickly secured to cable 501 without requiring the use of any external tools or fasteners.

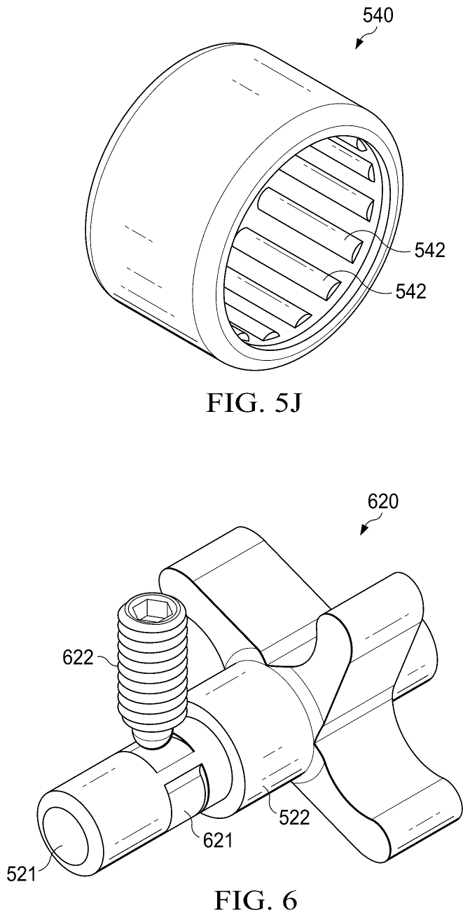

FIG. 6 illustrates a turnstile 620 with a cam-driven ratchet that may be used as turnstiles 520 in dual turnstile cable support 500, according to certain embodiments. In this embodiment, the embodiments of dual turnstile cable support 500 have been modified to include cam lobes 621. Cam lobes 621 are indentations on a camshaft (e.g., central shafts 521) at various/regular intervals that compress and decompress a spring plunger 622. Spring plunger 622 may be coupled to any appropriate portion of housing 530 using any appropriate fastener. As illustrated in FIG. 6, cam lobes 621 have a sloped shape (i.e., the depths of cam lobes 621 vary around the diameter of central shaft 521). By using spring plunger 622 to follow the varying depths of cam lobes 621, turnstile 620 will have a ratcheting feel when turning. Turnstile 620 will only spin in a single direction under normal use but can be overpowered to rotate in the opposite direction if needed. Turnstile 620 may be used instead of or in addition to one-way locking bearing clutches 540.

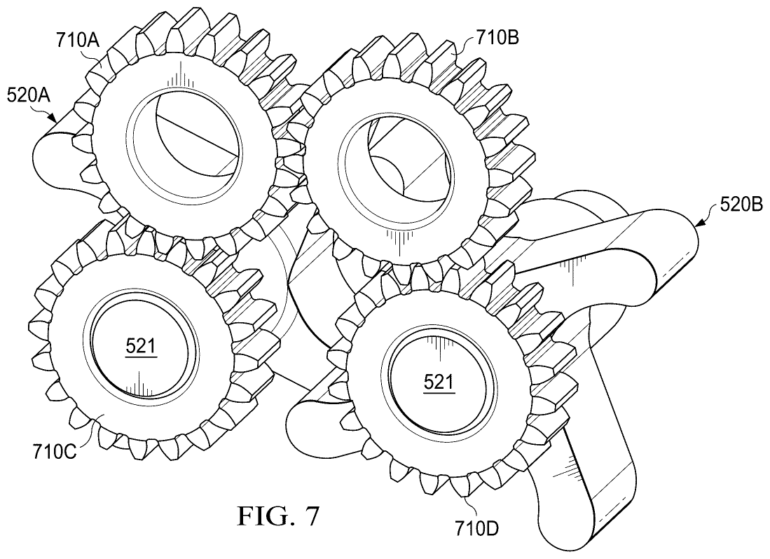

FIG. 7 illustrates an embodiment of dual turnstile cable support 500 that includes turnstiles 520A and 520B with gear-driven timing, according to certain embodiments. In this embodiment, four gears 710 (i.e., 710A-D) have been added to dual turnstile cable support 500 as illustrated in order to synchronize the motion of turnstiles 520. For example, gear 710C may be attached to central shaft 521 of turnstile 520A and may interlock with gear 710A. Gear 710A interlocks with gear 710B. Gear 710D may be attached to central shaft 521 of turnstile 520B and may interlock with gear 710B. Gears 710 may be attached to any appropriate location of housing 530 (e.g., second housing section 532) using any appropriate fastener or technique. As a result, turnstiles 720 may be prevented from spinning independently of each other.

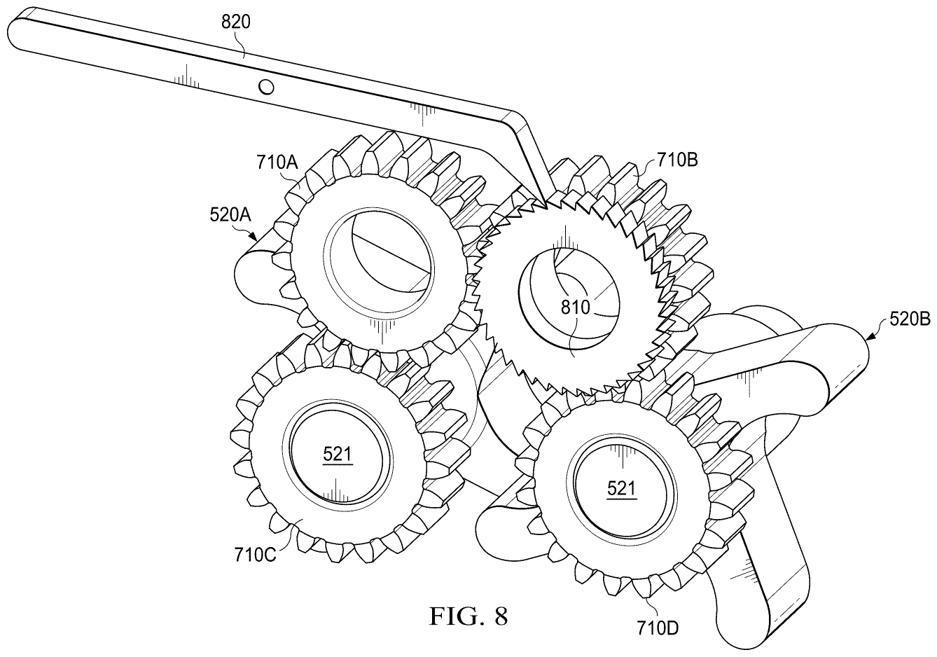

FIG. 8 illustrates an embodiment of dual turnstile cable support 500 that includes turnstiles 520A and 520B geared with a ratchet, according to certain embodiments. In this embodiment, the embodiment of dual turnstile cable support 500 in FIG. 7 has been further modified to include a ratchet 810 and a pawl 820 to ensure one direction of movement of turnstiles 520. Pawl 820 may be attached to any appropriate location of housing 530 (e.g., second housing section 532) using any appropriate fastener or technique. In some embodiments, as illustrated, ratchet 810 may be attached to gear 710B. In other embodiments, ratchet 810 may be attached to any other gear 710. In some embodiments, an end portion of pawl 820 may extend through housing 530 and may be accessible from outside housing 530 in order to allow the mechanism to be manually unlocked, thereby allowing turnstiles 520 to freely rotate in the opposite direction and thus releasing cable 501 within cable aperture 560.

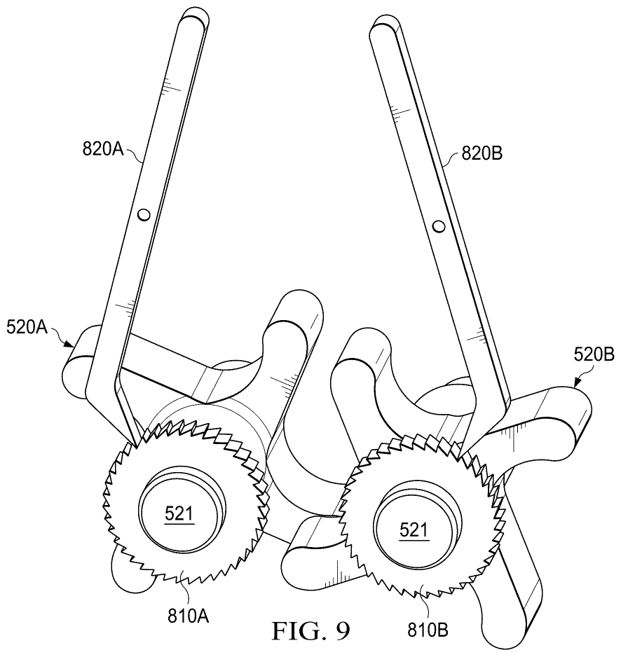

FIG. 9 illustrates an embodiment of dual turnstile cable support 500 that includes turnstiles 520A and 520B with double ratchets, according to certain embodiments. In this embodiment, two ratchets 810 (e.g., 810A and 810B) and two pawls 820 (e.g., 820A and 820B) have been added to dual turnstile cable support 500 as illustrated in order to limit the direction of rotation of turnstiles 520 to only one direction. For example, ratchet 810A may be attached to central shaft 521 of turnstile 520A and ratchet 810B may be attached to central shaft 521 of turnstile 520B. Pawl 820A may be coupled with ratchet 810A and pawl 820B may be coupled with ratchet 810B. Pawls 820 may be attached to any appropriate locations of housing 530 (e.g., second housing section 532) using any appropriate fastener or technique. In some embodiments, end portions of pawls 820 may extend through housing 530 and may be accessible from outside housing 530 in order to allow the mechanisms to be manually unlocked, thereby allowing turnstiles 520 to freely rotate in the opposite direction and thus releasing cable 501 within cable aperture 560. As a result, turnstiles 520 may be locked to only a single direction of rotation by default using ratchets 810 and pawls 820 but may be manually unlocked, thereby allowing turnstiles 520 to freely rotate in the opposite directions and thus releasing cable 501 within cable aperture 560.

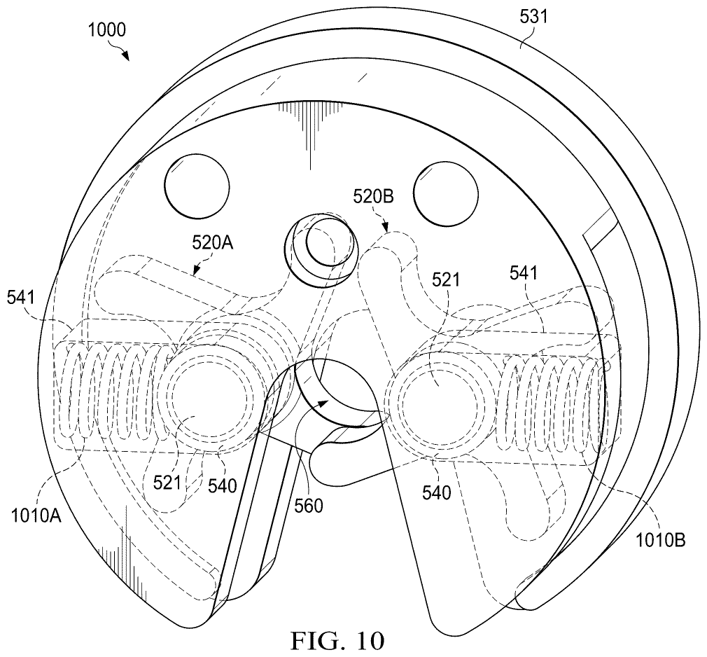

FIG. 10 illustrates a dual turnstile cable support 1000 that includes turnstiles 520A and 520B with tight turnstile springs 1010, according to certain embodiments. In this embodiment, two turnstile springs 1010 (e.g., 1010A and 1010B) have been added to dual turnstile cable support 500 as illustrated in order to permit turnstiles 520 to be manually pushed apart, thereby releasing cable 501 from cable aperture 560. This may allow dual turnstiles cable support 1000 to be easily removed from cable 501 without cutting cable 501. In some embodiments, a first spring 1010A is attached to central shaft 521 of turnstile 520A and a second spring 1010B is attached to central shaft 521 of turnstile 520B, as illustrated. In other embodiments, only a single turnstile spring 1010 may be used. As disclosed herein, one or both of turnstiles 520 may be locked to be unidirectional using one-way locking bearing clutches 540. However, if the mechanism is jammed, one or both of springs 1010A-B may be manually compressed in order to allow turnstiles 520 to move away from each other and thereby expand cable aperture 560 to release cable 501. In some embodiments, one or both of bearing seats 541 may be grooves or rectangular in shape instead of being circular in order to house turnstile springs 1010 and to permit central shafts 521 to slide toward or away from each other. In some embodiments, central shafts 521 are not coupled to or seated within bearing seat 541 of housing 530 at all, thereby allowing central shafts 521 to move away from each other.

In some embodiments, the embodiments of dual spring cable support 400 and dual turnstile cable support 500 disclosed herein may be removably coupled to any appropriate apparatus such as a shearing apparatus (e.g., shearing apparatus 102, shearing apparatus 200, etc.). In other embodiments, the embodiments of dual spring cable support 400 and dual turnstile cable support 500 disclosed herein may be permanently integrated into any appropriate apparatus such as shearing apparatus 102 and shearing apparatus 200.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “member,” “module,” “device,” “unit,” “component,” “element,” “mechanism,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

While the include figures illustrate particular embodiments having particular components, this disclosure contemplates other embodiments having some or all of the described components, as well as additional components not described. Components of the present disclosure may be any suitable shape and may be in any suitable configuration.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or. ” Similarly, as used in this document “and” is not necessarily inclusive and, unless expressly indicated otherwise, can be inclusive in certain embodiments and can be understood to mean “and/or.”

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A shearing apparatus comprising:
a torque conversion mechanism operable to be coupled to a torque generator;
a cutting nose in operable connection with the torque conversion mechanism, the cutting nose operable to sever a cable; and
a cable support operable to removably couple the shearing apparatus to the cable, the cable support comprising:
a central spring pin;
a first pivot pin;
a first pivoting cable support member configured to pivot about the first pivot pin and comprising a first cable notch;
a first spring coupled to the central spring pin and the first pivoting cable support member;
a second pivot pin;
a second pivoting cable support member configured to pivot about the second pivot pin and comprising a second cable notch; and
a second spring coupled to the central spring pin and the second pivoting cable support member;
wherein the first and second springs are configured to hold the first and second pivoting cable support members in a closed position; and
when the first and second pivoting cable support members are in the closed position, the first and second cable notches collectively form a cable aperture that is shaped to at least partially surround the cable, thereby securing the shearing apparatus to the cable.

2. The shearing apparatus of claim 1, wherein:
the cable support is removably coupled to the shearing apparatus; or
the cable support is permanently integrated into the shearing apparatus.

3. The shearing apparatus of claim 1, wherein each of the first and second pivoting cable support members comprises a cable groove edge that is configured to contact the cable and guide the cable into the cable aperture.

4. The shearing apparatus of claim 1, wherein each of the first and second pivoting cable support members comprises:
a first stepped profile portion having a first thickness; and
a second stepped profile portion having a second thickness that is less than the first thickness; and
a spring attachment location on the second stepped profile portion.

5. The shearing apparatus of claim 4, wherein:
the first spring is coupled to the first pivoting cable support member at the spring attachment location of the first pivoting cable support member; and
the second spring is coupled to the second pivoting cable support member at the spring attachment location of the second pivoting cable support member.

6. The shearing apparatus of claim 1, wherein the first cable notch and the second cable notch are each semi-circular in shape.

7. The shearing apparatus of claim 1, wherein:
the first pivoting cable support member comprises a first pivoting pin aperture that enables the first pivoting cable support member to pivot about the first pivot pin; and
the second pivoting cable support member comprises a second pivoting pin aperture that enables the second pivoting cable support member to pivot about the second pivot pin.

8. A cable support apparatus operable to removably couple a shearing apparatus to a cable, the cable support apparatus comprising:
a central spring pin;
a first pivot pin;
a first pivoting cable support member configured to pivot about the first pivot pin and comprising a first cable notch;
a first spring coupled to the central spring pin and the first pivoting cable support member;
a second pivot pin;
a second pivoting cable support member configured to pivot about the second pivot pin and comprising a second cable notch; and
a second spring coupled to the central spring pin and the second pivoting cable support member;
wherein the first and second springs are configured to hold the first and second pivoting cable support members in a closed position; and
when the first and second pivoting cable support members are in the closed position, the first and second cable notches collectively form a cable aperture that is shaped to at least partially surround the cable, thereby securing the shearing apparatus to the cable.

9. The cable support apparatus of claim 8, wherein:
the cable support apparatus is removably coupled to the shearing apparatus; or
the cable support apparatus is permanently integrated into the shearing apparatus.

10. The cable support apparatus of claim 8, wherein each of the first and second pivoting cable support members comprises a cable groove edge that is configured to contact the cable and guide the cable into the cable aperture.

11. The cable support apparatus of claim 8, wherein each of the first and second pivoting cable support members comprises:
a first stepped profile portion having a first thickness; and
a second stepped profile portion having a second thickness that is less than the first thickness; and
a spring attachment location on the second stepped profile portion.

12. The cable support apparatus of claim 11, wherein:
the first spring is coupled to the first pivoting cable support member at the spring attachment location of the first pivoting cable support member; and
the second spring is coupled to the second pivoting cable support member at the spring attachment location of the second pivoting cable support member.

13. The cable support apparatus of claim 8, wherein the first cable notch and the second cable notch are each semi-circular in shape.

14. The cable support apparatus of claim 8, wherein:
the first pivoting cable support member comprises a first pivoting pin aperture that enables the first pivoting cable support member to pivot about the first pivot pin; and
the second pivoting cable support member comprises a second pivoting pin aperture that enables the second pivoting cable support member to pivot about the second pivot pin.

15. A method of shearing a cable in a concrete support system, the method comprising:
attaching a shearing apparatus to a cable using a cable support of the shearing apparatus, the shearing apparatus comprising:
a central spring pin;
a first pivot pin;
a first pivoting cable support member configured to pivot about the first pivot pin and comprising a first cable notch;
a first spring coupled to the central spring pin and the first pivoting cable support member;
a second pivot pin;
a second pivoting cable support member configured to pivot about the second pivot pin and comprising a second cable notch; and
a second spring coupled to the central spring pin and the second pivoting cable support member;
wherein the first and second springs are configured to hold the first and second pivoting cable support members in a closed position; and
when the first and second pivoting cable support members are in the closed position, the first and second cable notches collectively form a cable aperture that is shaped to at least partially surround the cable, thereby securing the shearing apparatus to the cable; and
severing the cable by applying torque to the shearing apparatus via a torque generator.

16. The method of claim 15, wherein:
the cable support apparatus is removably coupled to the shearing apparatus; or
the cable support apparatus is permanently integrated into the shearing apparatus.

17. The method of claim 15, wherein each of the first and second pivoting cable support members comprises a cable groove edge that is configured to contact the cable and guide the cable into the cable aperture.

18. The method of claim 15, wherein each of the first and second pivoting cable support members comprises:
a first stepped profile portion having a first thickness; and
a second stepped profile portion having a second thickness that is less than the first thickness; and
a spring attachment location on the second stepped profile portion.

19. The method of claim 18, wherein:
the first spring is coupled to the first pivoting cable support member at the spring attachment location of the first pivoting cable support member; and
the second spring is coupled to the second pivoting cable support member at the spring attachment location of the second pivoting cable support member.

20. The method of claim 15, wherein the first cable notch and the second cable notch are each semi-circular in shape.
